(19) United States
(12) Patent Application Publication
(10) Pub. No.: US 2024/0095409 A1
(43) Pub. Date: Mar. 21, 2024

(54) PHYSICAL UNCLONABLE FUNCTION DEVICE AND SECURITY MODULE INCLUDING SAME

(71) Applicant: KOREA ADVANCED INSTITUTE OF SCIENCE AND TECHNOLOGY, Daejeon (KR)

(72) Inventors: Sang Ouk KIM, Daejeon (KR); Bong Hoon KIM, Seoul (KR); Jang Hwan KIM, Daejeon (KR)

(73) Assignee: KOREA ADVANCED INSTITUTE OF SCIENCE AND TECHNOLOGY, Daejeon (KR)

(21) Appl. No.: 18/262,933

(22) PCT Filed: Mar. 17, 2022
(86) PCT No.: PCT/KR2022/003755

§ 371 Date: Jul. 26, 2023

(30) Foreign Application Priority Data
Mar. 17, 2021 (KR) 10-2021-0034690

(51) Int. Cl. G06F 21/75; H01L 23/00; H01L 29/06; H04L 9/32

(52) U.S. Cl. CPC G06F 21/75; H01L 23/573; H01L 29/0665; H04L 9/3278

(57) ABSTRACT

The present invention relates to a device for a physical unclonable function having unique characteristics, and the device for a physical unclonable function according to the present invention includes a nano-pattern corresponding to a self-assembled structure. As the device for a physical unclonable function according to the present invention has a PUF pattern based on a self-assembled structure formed by spontaneous phase separation behavior of a block copolymer having non-deterministic characteristics, the device for a physical unclonable function may have unclonable unique characteristics.

### CROSS-REFERENCE TO RELATED APPLICATIONS

This application is a 35 U.S.C. § 371 national phase of PCT International Application No. PCT/KR2022/003755, filed Mar. 17, 2022, which claims the benefit of priority under 35 U.S.C. § 119 to Korean Patent Application No. 10-2021-0034690, filed Mar. 17, 2021, the contents of which are incorporated herein by reference in its entirety.

### FIELD

The present invention relates to a device for a physical unclonable function, a secure module including the same, and a method of manufacturing a device for a physical unclonable function.

### BACKGROUND

Due to the rapid development of IT technology, new cutting-edge devices such as the Internet of Things (IoT) are appearing at a rapid pace, but economic and industrial losses due to counterfeiting, hacking, or the like are increasing day by day. To solve this problem, a new technology called a physical unclonable function (PUF) is being developed. The PUF is a technology that each device has unique characteristics like biometric information such as a human fingerprint or iris, and the unique characteristics may not be cloned even if each device is manufactured in the same process. Accordingly, since there is no need to separately store a key generated through the physical unclonable technology, security stability may be greatly increased, and the generated key may be used to encrypt data requiring security, authenticate a device requiring security, or the like.

The PUF technology that is currently receiving the most attention is a technology of stochastically determining whether an inter-layer contact or a via is generated between conductive layers of a semiconductor using a process variation of the semiconductor. However, the PUF technology based on semiconductor process variation has limitations in miniaturization since the via size needs to be adjusted to an optimal size in order to generate a true random number, and has a problem in that, even in the same process, the PUF yield is lowered since the optimal via size is substantially different due to the difference in process variation for each individual wafer or individual chip. In addition, there are attempts to implement PUF technology using active elements such as diodes, transistors, and SRAMs, but the PUF technology based on such active elements has a problem in that stability against external stimuli such as temperature is lowered. (Korean Patent Laid-Open Publication No. 2010-0125633)

### SUMMARY

An object of the present invention is to provide a PUF device having a high encryption capacity while having an ultra-fine size of several tens of micrometers.

Another object of the present invention is to provide a PUF device that may not be physically cloned by a conventional microstructure preparing process such as lithography.

Another object of the present invention is to provide a PUF device having significantly improved security by having a plurality of different unique characteristics even if the PUF device is a physically single device.

Another object of the present invention is to provide a PUF device that may be attached to any surface due to its flexibility, may stably maintain its unique characteristic against external stimuli such as mechanical deformation and temperature, and may be effectively used for biometric recognition beyond objects due to its ultra-fine size.

In one general aspect, a device for a physical unclonable function (hereinafter, PUF device) includes a nano-pattern corresponding to a self-assembled structure.

The nano-pattern may be a pattern corresponding to a pattern of one of the two materials forming the self-assembly structure.

The self-assembled structure may be a self-assembled structure by spontaneous phase separation of a polymer.

The self-assembled structure may be a random lamellar structure.

The nano-pattern may be an organic pattern or an inorganic pattern.

The device may further include a laminate in which two or more nano-patterns having different patterns are stacked.

The self-assembled structure may have 5 to 20 defects per 1 μm² area.

The device may further include an electrode set that is electrically connected to the nano-pattern and includes three or more electrodes spaced apart from each other.

A private key of the device may be based on one or more of unique characteristics I) and II) below.
I) Shape characteristic
II) Defect characteristic

The inorganic pattern may be a metal pattern, a semiconductor pattern, or an insulator pattern.

The private key of the device may be based on one or more of unique characteristics of I) to IV) below.
I) Shape characteristic
II) Defect characteristic
III) Response characteristic to electrical stimulus
IV) Response characteristic to light stimulus

The defect characteristic may include binary image information of a defect.

The defect may include terminations or bifurcations or the terminations and bifurcations.

When the device includes the laminate in which two or more nano-patterns having different patterns are stacked, the defect may include crossing points of the two nano-patterns.

The shape characteristic may include binary image information of the nano-pattern.

The response characteristic to the electrical stimulus may include electrical resistance measured for each different electrode pair from an electrode set including three or more electrodes electrically connected to the nano-pattern.

The response characteristic to the light stimulus may include reflectance for each wavelength of polarized light.

The PUF device may generate two or more private keys independent of each other from each of the two or more pieces of information in the above I) to IV).

In another general aspect, a secure module includes the above-described PUF device.

In still another general aspect, a method of manufacturing a device for a physical unclonable function includes: a) preparing a thin film of spontaneous phase separated self-assembled structure by forming a thin film of a block copolymer on a substrate and annealing the thin film; and b) removing one of unit blocks of the block copolymer from the thin film of the self-assembled structure.

The method may further include, after step b), stacking a nano-pattern obtained by removing one block.

The method may further include: after step b), c) preparing an organic-inorganic composite thin film by filling the empty space from which the one block is removed with an inorganic matter; and d) obtaining an inorganic pattern by removing an organic matter from the block copolymer from the organic-inorganic composite thin film.

The method may further include, after step d), e) stacking a nano-pattern obtained by removing the organic matter.

The inorganic matter may be a metal, a semiconductor, or an insulator.

The method may further include, after step d), forming three or more electrodes electrically connected to the nano-pattern obtained by removing the organic matter, and connected to the nano-pattern at different positions.

According to an embodiment of the invention, as the PUF device has a PUF pattern based on a self-assembled structure formed by spontaneous phase separation behavior of block copolymers with a non-deterministic characteristic, the PUF device may have unique characteristics that may not be cloned, may stably maintain its unique characteristics due to a nano-pattern of an inorganic material even when the external environment such as temperature changes, may have excellent security by having a variety of unique characteristics independent of each other, including a shape characteristic, a defect characteristic, an electrical characteristic, and an optical characteristic, may be miniaturized by having a very high encryption capacity even with only 1 μm×1 μm area, and may be easily introduced into objects, such as human skin, which are deformable and have a curved surface by having excellent flexibility due to its thickness of several tens of nm.

### BRIEF DESCRIPTION OF THE DRAWINGS

FIG. 1 is a scanning electron microscope of a random lamellar structure of a typical block copolymer.

FIG. 2 is a scanning electron micrograph of a metal pattern prepared using the random lamellar structure of FIG. 1.

FIG. is 3 is a scanning electron microscope of single metal pattern (mono-layer), a laminate (bi-layers) in which two metal patterns are stacked, a laminate (triple-layers) in which three metal patterns are stacked, and a laminate (quadruple-layers) in which four metal patterns are stacked, which are observed in a top-down direction, and a schematic diagram of each laminate.

FIG. 4 is a diagram illustrating an example of generating a private key using a PUF region (sub PUF A) shown by a red dotted line and a PUF region (sub PUF B) shown by a blue dotted line within a PUF pattern in a PUF device (nano PUFs).

FIG. 5 is an example illustrating an extraction of terminal defects from a single-layer nano-pattern.

FIG. 6 is an example illustrating an extraction of defect patterns for each nano-pattern from a laminate in which two nano-patterns are stacked.

FIG. 7 is an example of generating a private key using a defect characteristic in the laminate in which two nano-patterns are stacked.

FIG. 8 is a schematic diagram illustrating a conductive path in the laminate in which two nano-patterns are stacked.

FIG. 9 is an optical photograph of observing a PUF device in which five electrodes are formed at different positions in a laminate in which two layers of metal patterns are stacked.

FIG. 10 is a diagram illustrating a result of measuring electrical resistance for each different electrode pair selected from five electrode groups in the PUF device of FIG. 9.

FIG. 11 is an example of generating a private key using electrical unique characteristics in the laminate in which two nano-patterns are stacked.

FIG. 12 is a diagram illustrating measurement of reflectance according to a wavelength of light when polarized light is irradiated to the PUF device.

FIG. 13 is a diagram illustrating color mapping of metal layer orientation in a laminate in which a single metal pattern and two metal patterns are stacked.

FIG. 14 is a diagram illustrating reflectance spectra according to a polarization direction and a wavelength (600 to 800 nm) of light obtained for each sub PUF region.

FIG. 15 is an example of generating a private key using optical unique characteristics in the laminate in which two nano-patterns are stacked.

FIG. 16 is an example of introducing the PUF device into various objects.

### DETAILED DESCRIPTION

Hereinafter, a PUF device of the present disclosure will be described in detail with reference to the accompanying drawings. Drawings to be provided below are provided by way of example so that the spirit of the present invention may be sufficiently transferred to those skilled in the art. Therefore, the present invention is not limited to the accompanying drawings provided below, but may be modified in many different forms. In addition, the accompanying drawings suggested below will be exaggerated in order to clear the spirit and scope of the present invention. Technical terms and scientific terms used in the present specification have the general meaning understood by those skilled in the art to which the present invention pertains unless otherwise defined, and a description for the known function and configuration unnecessarily obscuring the gist of the present invention will be omitted in the following description and the accompanying drawings.

In addition, a singular form used in the specification and the appended claims may be intended to include a plural form unless otherwise indicated in the context.

In this specification and the appended claims, terms such as first, second, etc., are used for the purpose of distinguishing one component from another, not in a limiting sense.

In this specification and the appended claims, the terms “include” or “have” means that features or elements described in the specification are present, and unless specifically limited, and do not preclude the possibility that one or higher other features or components may be added unless specifically limited.

In this specification and the appended claims, a case in which a part of a film (layer), a region, a component, etc., is above or on another part includes not only a case in which the part is directly on another part in contact with another part, but also a case in which another film (layer), another region, another component, etc., is interposed therebetween.

The present invention provides a PUF device having unique characteristics for physical unclonable with a self-assembled structure having a non-deterministic characteristic.

The PUF device according to the present invention includes a nano-pattern corresponding to the self-assembled structure. The nano-pattern is an element that expresses the unclonable unique characteristics of the PUF.

The self-assembled structure may be a self-assembled structure by spontaneous phase separation of a polymer. Representative examples of the polymer that forms the self-assembled structure by the spontaneous phase separation may include a block copolymer, but the polymer in which the spontaneous phase separation takes place is not necessarily limited to the block copolymer. This is because, as the self-assembly process by the spontaneous phase separation itself is a non-deterministic and stochastic reaction, the nano-pattern that may ensure the unclonable unique characteristics of the PUF may be implemented as long as the self-assembled structure is formed by the spontaneous phase separation. Accordingly, substantially independent of a spherical polymer material, any pattern of any polymer material known to form the self-assembled structure by the spontaneous phase separation may function as a PUF pattern.

As described above, a representative polymer in which the self-assembled structure by the spontaneous phase separation is formed is a block copolymer. Accordingly, in the PUF device according to the embodiment of the present invention, the self-assembled structure may be the self-assembled structure by the spontaneous phase separation of the block copolymer. Since the self-assembly by the spontaneous phase separation of the block copolymer is the non-deterministic reaction, even if the self-assembled structure is formed with the same material and the same process, a different self-assembled structure is obtained each time the self-assembled structure is prepared. Accordingly, the self-assembled structure of the block copolymer satisfies the unclonable property which is fundamental and essential for a physical unclonable device.

As is well known, the block copolymer in which two or more chemically distinct polymer chains are linked by a covalent bond is separated into a microphase by the self-assembly characteristic. Representative examples of the chemically distinct polymer chains may include hydrophilic polymer chains and hydrophobic polymer chains, and examples of the block copolymer may include random copolymers of hydrophilic unit blocks and hydrophobic unit blocks. The microphase separation by the self-assembly of the block copolymer is previously described by factors such as a volume fraction and molecular weight of the unit block, a mutual attraction coefficient, and mutual attraction between the block copolymer and the substrate, and the spherical self-assembled structure formed by the conditions of each factor is also well established.

The self-assembled structure may include a lamellar structure, a cylindrical structure, a spherical structure, a mixture thereof, or the like. A unique key of the PUF device may be generated by a geometrical unique characteristic of the self-assembled structure.

Specifically, the nano-pattern may be a pattern corresponding to a pattern of one of the two materials forming the self-assembled structure. In this case, the two materials may mean two unit blocks forming the block copolymer. Accordingly, the nano-pattern may be a pattern corresponding to the pattern of one of the two unit blocks of the block copolymer forming the self-assembled structure.

In an advantageous example, the self-assembled structure may be a random lamellar structure, and the random lamellar structure may be a random vertical lamellar structure. In addition to the geometrical unique characteristic, the random lamellar structure may have various unique characteristics independent of the geometrical unique characteristic, and is advantageous because the random lamellar structure has a higher encryption capacity than any other self-assembled structure. When the self-assembled structure is the random lamellar structure, the nano-pattern includes a nano-pattern having a pattern corresponding to the pattern of one of the two material layers constituting the random lamellar structure.

That is, in the random lamellar structure in which the block copolymer is spontaneous phase separated, the PUF device according to an advantageous example may include a nano-pattern having a pattern corresponding to the pattern of one of the unit blocks of the block copolymer forming the random lamellar structure. When the nano-pattern has the random lamellar structure, since the nano-pattern has a lamellar cycle on the order of several to tens of nanometers, the nano-pattern may have a very high encryption capacity even in an ultra-fine region of only 1 μm×1 μm and may also have unique characteristics due to defects such as terminations or bifurcations together with the unique characteristics due to the shape of the pattern itself.

The nano-pattern may be an organic pattern in which the material forming the pattern is an organic material or an inorganic pattern in which the material forming the pattern is an inorganic matter. The inorganic matter of the inorganic pattern may be a metal, a semiconductor, an insulator, a mixture thereof, or a composite thereof. The inorganic matter with a bandgap energy exceeding 2.5 eV may be generally classified as an insulator. Substantially, the insulator may be oxide, nitride, carbide, oxynitride, or the like of one or two or more elements selected from transition metal, post-transition metal, and non-metal, but is not limited thereto. The metal may be one or more selected from the group consisting of alkali metals, alkaline earth metals, transition metals, and post-transition metals, alloys thereof, or the like, and examples thereof include copper, gold, silver, platinum, stainless steel, aluminum, etc., but are not limited thereto. The inorganic matter having a bandgap energy exceeding 0 and less than or equal to 2.5 eV or less may generally be classified as a semiconductor. Examples of the semiconductor may include compounds of groups IV, III, and V of the periodic table, compounds of groups II and VI, or the like, and specifically, Si, Ge, Si—Ge, GaP, GaAs, InSb, ZnS, CdS, ZnTe, CdTe, and the like, but is not limited thereto. The organic matter of the organic pattern may be one of the two materials forming the block copolymer or a heterogeneous organic matter different therefrom. The heterogeneous organic matter may be a conductive polymer or an insulating polymer. The conductive polymer may be any one or two or more selected from a polyacetylene-based polymer, a polyaniline-based polymer, a polypyrrole-based polymer, a polythiophene-based polymer, and the like, but is not limited thereto. The insulating polymer may include a siloxane-based resin, an olefin-based elastic resin or a polyurethane-based resin, an ethylene-based resin, a propylene-based resin, a styrene-based resin, a methacrylic resin, a vinyl alcohol-based resin, a vinyl chloride-based resin, an olefin-based resin, an ester-based resin, an amide-based resin, a urethane-based resin, a carbonate-based resin, a phenol-based resin, a urea-based resin, a melamine-based resin, an unsaturated ester-based resin, an epoxy-based resin, a silicone-based resin, a fluorine-based resin, a phthalate-based resin, mixtures thereof, composite resins thereof, or the like, but is not limited thereto.

As an example of a preparing method, the organic pattern may be a nano-pattern obtained by removing one block (layer of one block material of the block copolymer) from the self-assembled structure of the block copolymer. On the other hand, the organic pattern or inorganic pattern prepared by filling a space from which one block is removed with the inorganic matter or heterogeneous organic matter by using, as a mold, a pattern (organic pattern) obtained by removing one block (layer of one block material of the block copolymer) from the random lamellar structure of the block copolymer. Accordingly, the nano-pattern, which is the organic pattern or inorganic pattern, may have the same dimension (size) and the same shape as the layer of one block material having the random lamellar structure of the block copolymer.

In an advantageous example, the nano-pattern may be the inorganic pattern. When the PUF device includes the inorganic pattern, it is advantageous because the unique characteristics may be stably maintained even when the change in external environment such as temperature or contact with external substances occur due to the unique material stability of the inorganic matter.

A height of the self-assembled structure in the self-assembled structure of the block copolymer may be at a level of 5 to 50 nm, a size of the sphere or cylinder in the spherical structure or cylinder structure may be a level of 10 to 300 nm, and the lamellar cycle in the lamellar structure may be a level of 20 to 200 nm, but the present invention is not limited thereto. As the nano-pattern has a pattern corresponding to the self-assembled structure, the nano-pattern may have substantially the same size and shape as one material forming the self-assembled structure. For example, when the self-assembled structure is the random lamellar structure, as the nano-pattern has the same pattern as one material layer pattern of the random lamellar structure, the nano-pattern may also have a height of 5 to 50 nm and a cycle of 20 to 200 nm.

Accordingly, the nano-pattern may have excellent flexible properties due to its extremely thin thickness, and may have a very high encryption capacity by being patterned at a nanoscale.

In an advantageous example, the PUF device may include a laminate in which two or more nano-patterns having different patterns are stacked. Specifically, the laminate may be configured so that adjacent nano-patterns are stacked in contact with each other.

A single nano-pattern may be used as the PUF device, but when a laminate in which a plurality of nano-patterns are stacked is used as the PUF device, it is advantageous because the very high encryption capacity can be secured even in a smaller size (area). As a practical example, the laminated may be a laminate in which 2 to 6 nano-patterns, more substantially 2 to 5 nano-patterns, and even more substantially 2 to 4 nano-patterns are stacked, but the present invention is not necessarily limited thereto.

Hereinafter, according to an advantageous example, the PUF device is described in detail based on an example including the nano-pattern (inorganic pattern) of the inorganic matter corresponding to one material layer of the random lamellar structure by the spontaneous phase separation of the block copolymer, but the present invention does not exclude other self-assembled structures or nano-patterns of organic matter.

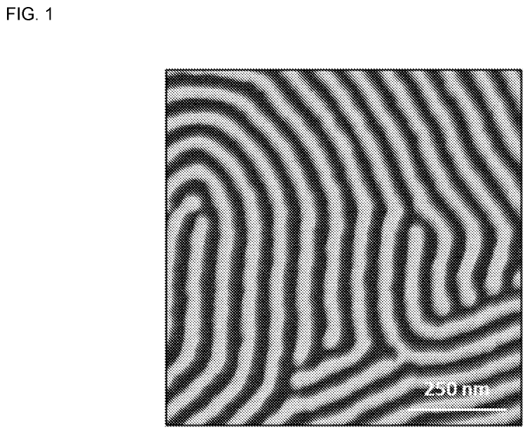

FIG. 1 is a scanning electron microscope of a random lamellar structure of a typical block copolymer. In FIG. 1, a white part is a layer of one unit block A of the block copolymer, and a black part is a layer of another unit block B. The random lamellar structure of FIG. 1 is obtained by spin-casting a copolymer solution obtained by dissolving a polystyrene-b-polymethylmethacrylate (PS-b-PMMA) random copolymer with 1.5 wt % of toluene on a neutral-treated silicon oxide substrate and then annealing the copolymer solution for two hours at room temperature under tetrahydrofuran (THF) vapor atmosphere. In this case, as the PS-b-PMMA random copolymer, a first PS-b-PMMA copolymer in which Mn of a polystyrene block is 105 kg/mol and Mn of a polymethyl methacrylate block is 106 kg/mol and a second PS-b-PMMA copolymer in which the Mn of the polystyrene block is 5 kg/mol and the Mn of the polymethyl methacrylate block is 5 kg/mol are mixed in a weight ratio of 7:3 and used. By using the block copolymer of the low molecular weight block and the block copolymer of the relatively high molecular weight block together, the lamellar cycle of the random lamellar structure may be reduced. However, this is only an example of preparing the random lamellar structure, and the random lamellar structure of the block copolymer may be prepared using a conventionally well-known method (refer to Korean Patent Laid-Open Publication No. 2017-0054672, etc.).

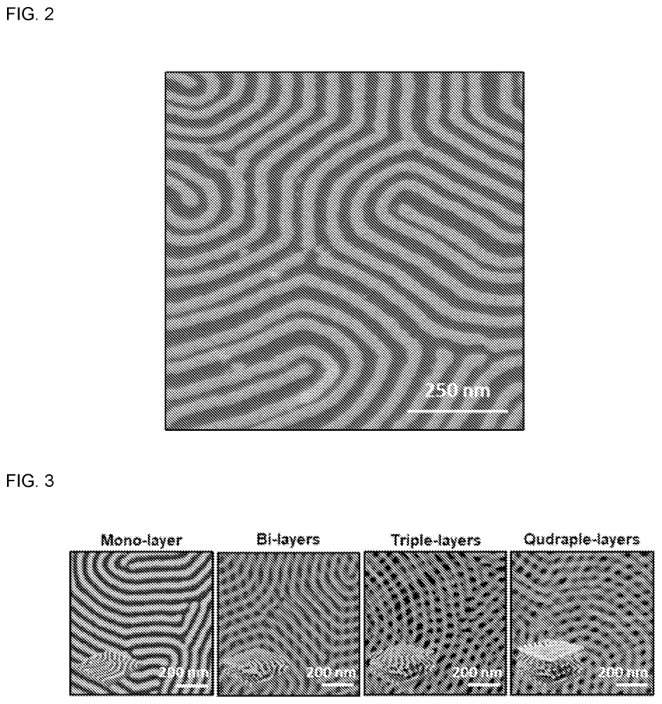

FIG. 2 is a scanning electron microscope of a metal pattern prepared by removing a white unit block A from the random lamellar structure of FIG. 1 using O₂ plasma reactive ion etching, using the unit block as a molding flask, filling a space from which the one unit block A is removed by electron-beam deposition of metal Pt with metal, and removing the remaining other unit block (other unit block B of the block copolymer). As may be seen from FIG. 2, in the random lamellar structure of the block copolymer, a metal layer (metal pattern) having the same pattern as that of one of the unit blocks of the block copolymer forming the random lamellar structure is prepared. In this case, the random lamellar structure of the block copolymer has a shape substantially similar to a human fingerprint, and thus may have a shape similar to a metal pattern or a valley or mountain of a fingerprint.

FIG. is 3 is a scanning electron microscope of single metal pattern (mono-layer), a laminate (bi-layers) in which two metal patterns are stacked, a laminate (triple-layers) in which three metal patterns are stacked, and a laminate (quadruple-layers) in which four metal patterns are stacked, which are observed in a top-down direction, and a schematic diagram of each laminate. In the scanning electron micrograph, each metal layer is shown with a different color for clear recognition of each metal pattern constituting the laminate.

It may be seen that the single metal pattern also has a geometrical unique characteristic by a pattern corresponding to one layer (layer of one unit block of the block copolymer) of the random lamellar structure, resulting in ensuring the uniqueness of the device. However, in the case of the laminate in which the metal pattern is stacked, the shape of the pattern (pattern in which the metal patterns constituting the laminate is merged) of the laminate becomes highly complex, the uniqueness of the device becomes more firm, and the encryption capacity is increased, which is advantageous.

Specifically, as the number of stacked layers of the metal pattern increases and the complexity (information entropy) of the pattern increases, a standard deviation of a fractal dimensional distribution also decreases, resulting in a completely unpredictable and highly complex random pattern over a wide pattern region.

Accordingly, according to an advantageous example, when the PUF device includes a laminate of nano-patterns, a device unique key (private key) of a complete random number may be generated with a geometrical unique characteristic.

Further, according to an advantageous example, when the PUF device includes the laminate of the nano-patterns, since the pattern of the laminate has a very high encryption capacity even when only the two nano-patterns are stacked to enable a very high encoding capacity of at least 4.8×10³⁵ within a region of 1 μm×1 μm, thereby implementing the ultra-fine PUF device.

Hereinafter, in describing the unique characteristics of the device, the pattern of the laminate in which a single-layered nano-pattern or a plurality of nano-patterns are stacked is also referred to as a “PUF pattern.” In addition, if necessary, for clear understanding, when it is necessary to refer to each nano-pattern or a single nano-pattern constituting a laminate, Instead of the PUF pattern, it is specified using the term “single-layered nano-pattern” or “nano-pattern”, and when it is necessary to clearly refer to the laminate, it is specified using the term “pattern of a laminate” instead of using the PUF pattern.

In one embodiment, the geometrical unique characteristic may include a shape characteristic of the PUF pattern.

The shape characteristic of the PUF pattern may include binary image information of the PUF pattern. In this case, the binary image information may be binary image information of an entire region of the PUF pattern or a predetermined partial region. This is because the geometrical unique characteristic that generates a complete random number may be implemented only with a region of 1 μm×1 μm in size. Accordingly, the preset partial region may be ultra-fine regions of 1 μm×1 μm to 10 μm×10 μm.

In addition, when the partial region in the PUF pattern is used for the PUF, binary image information obtained from the pattern shape of the corresponding region may be obtained from each region having two or more preset positions and preset sizes. This is because, since the PUF pattern has a completely unpredictable random pattern in the entire region, each of the binary image information obtained for each region in regions at several different positions has the unique geometrical characteristic.

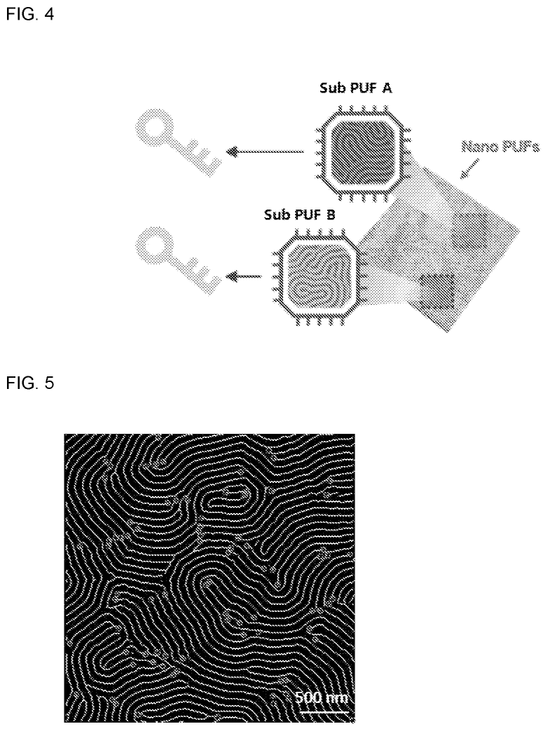

When the partial region of the PUF pattern used for the PUF is referred to as the PUF region, FIG. 4 illustrates an example in which, in the PUF devices (nano PUFs), each of the PUF region (sub PUF A) shown in red dotted lines and the PUF region (sub PUF B) shown in blue in the PUF pattern is used to implement the unique characteristics of the device. For each two PUF regions (sub PUF A and sub PUF B), the binary image information may be extracted from the pattern form of the corresponding region, and the private key may be generated from the extracted information. FIG. 4 illustrates an example in which two independent private keys are generated, but the present invention is not limited thereto. In one PUF pattern, private keys corresponding to the number of PUF regions used for the PUF may be generated. When the authentication or security is performed by a plurality of private keys, even if some keys are exposed to the outside, the counterfeiting, hacking, or the like can be prevented by the remaining keys.

When the PUF device includes the laminate in which two nano-patterns are stacked, it may be obtained as the binary image information of the PUF pattern (pattern of the laminate). The binary image information may be only a PUF pattern or monochrome image information in which the shape of the PUF region is converted into black (0) and white (1) images. In this case, when the PUF device includes the laminate, the shape of the PUF pattern may be a shape in which each nano-pattern constituting the laminate is merged. However, the binary image information is not limited to the pattern-shaped monochrome image information. For example, a response pattern obtained by performing an arithmetic or logical operation on an external stimulus, which may be referred to as a challenge pattern, may also belong to the binary image information. In this case, examples of the arithmetic or logical operation include, but are not limited to, operations such as logical sum (OR), logical product (AND), negation (NOT), and exclusive-OR (XOR). The response pattern to the challenge pattern may correspond to the shape of the PUF pattern, the challenge pattern, and a matrix-type two-dimensional code calculated by operation, and the response pattern may also be classified as the binary image information.

As in the example of FIG. 4, the pattern shapes of each different PUF region may be used as the geometrical unique characteristic. As in the example described above, the response pattern obtained by applying the challenge pattern to the entire PUF region or the PUF pattern and performing the arithmetic or logical operation may be used as the geometrical unique characteristic, and all of these may be used as the geometrical unique characteristic.

In one embodiment, the unique characteristics of the device generating the private key of the device may include a defect characteristic of the PUF pattern.

As the nano-pattern is due to the random lamellar structure of the block copolymer, the single-layered nano-pattern has topological defects. The topological defects include a termination in which layers are broken, or a bifurcation in which a single layer bifurcates into two or more layers. The pattern including the termination, the bifurcation, or both the termination and bifurcation also corresponds to the unique characteristics of the device.

In terms of the high encryption capacity, the lamellar structure of the block copolymer may include 5 to 20 defects per 1 μm² area, and accordingly, the nano-pattern may also include 5 to 20 defects per 1 μm² area.

The example of FIG. 5 illustrates the extraction of the termination defects from the single-layered nano-pattern, and the average number of defects formed in a region (PUF region) of about 8.5 μm² in size is about 85. That is, there are 10 terminations defects per 1 μm² area on average. Using a period of 60 nm of the lamellar structure, the 1 μm² area is set as a lattice of 17×17, and the number of lattice points, where defects may be formed, by the calculation reaches about 280. Accordingly, the number of cases in which different defect patterns are formed in the single-layered nano-pattern is about ₂₈₀C₁₀, which is 6.937×10¹⁷, and even if only two single-layered nano-patterns are stacked, 4.8×10³⁵ different defect patterns are formed in a 1 μm² area, so it may be seen that the uniqueness of the device is secured by the defect pattern.

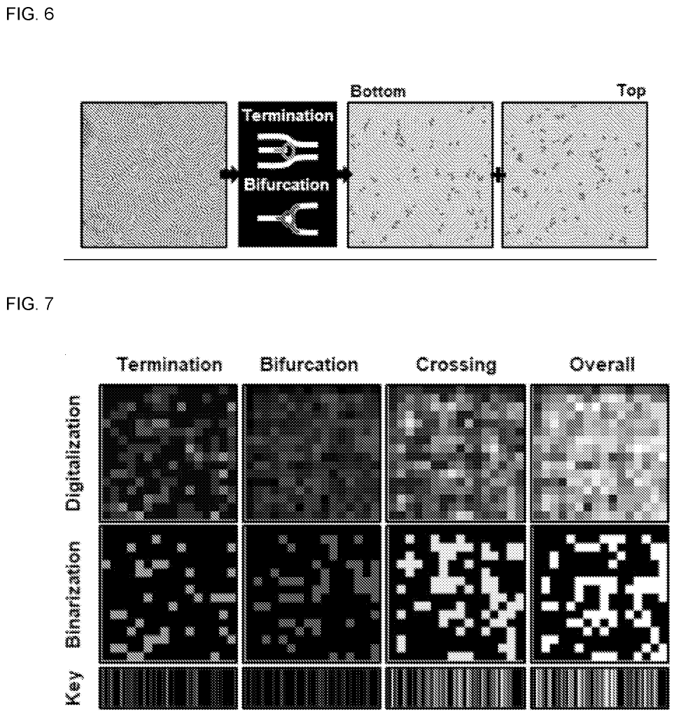

FIG. 6 illustrates an example in which the two nano-patterns are stacked. In a laminate (2 layers), a termination defect pattern is shown in red and the bifurcation defect pattern is shown in blue, for each of a nano-pattern (bottom) positioned on a lower portion and a nano-pattern (top) positioned on an upper portion The defect pattern of one nano-pattern may be a pattern in which the terminations defect pattern and the bifurcations defect pattern are merged, but the terminations defect pattern alone may be used or the bifurcations defect pattern alone may be used. In addition, the defect pattern of the laminate may be a pattern in which the defect patterns of the nano-pattern are merged. When two nano-patterns are stacked as illustrated in FIG. 6, the defect pattern of the lower nano-pattern and the defect pattern of the upper nano-pattern are merged to form the defect pattern of the laminate.

When the PUF device includes the laminate in which two or more nano-patterns having different patterns are stacked in addition to the defects present in the single-layered nano-patterns, the defects may include crossing points of two adjacent nano-patterns. That is, the defect pattern may include a pattern of crossing points (contact points between two nano-patterns) of two adjacent nano-patterns.

FIG. 7 illustrates an example of generating a private key using a defect characteristic of a pattern as the unique characteristics in the laminate in which two nano-patterns are stacked. FIG. 7 illustrates an example in which defect patterns are extracted from the sub PUF region for each defect type of the terminations, bifurcations, and crossing points, four types of defect patterns are digitally imaged with a specified pixel resolution by merging (overall) all the defect patterns, and the digital image is converted into a 1D binary key.

As described above, the unique characteristics of the PUF device may include the defect characteristic of the PUF pattern, and the defect characteristics as the unique characteristics may include d1: defect pattern for each single-layered nano-pattern reference defect type (termination, bifurcation, or crossing point), d2: a merged pattern in which defect pattern(s) for each single-layered nano-pattern reference defect type are merged (first merge pattern), d3: a merge pattern in which defect pattern(s) of d1 are merged by the same defect type based on the laminate (second merge pattern), d4: a merge pattern in which defect pattern(s) of each d2 are merged based on the laminate (third merge pattern), or a combination thereof (d1 to d4). The above-described defect pattern may be compatible with the conventional fingerprint pattern recognition-based identification algorithm.

In an advantageous example, the nano-pattern may be a metal pattern. When the nano-pattern is the metal pattern, it is advantageous because the nano-pattern may have the unique electrical characteristic along with the geometrical unique characteristic derived from the random lamellar structure of the block copolymer.

That is, when the nano-pattern is the metal pattern, the PUF device may have an electrical unique characteristic as an independent unique characteristic, along with the geometrical unique characteristic by the shape of the nano-pattern.

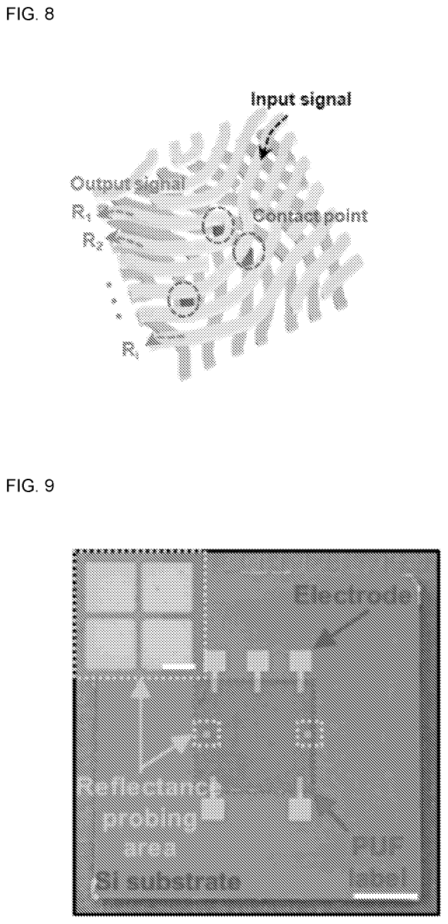

In detail, as the metal pattern has a pattern corresponding to the pattern of one of the unit blocks of the block copolymer forming the random lamellar structure, an electrical path connecting one position P1 to another position P2 of the metal pattern is determined by the pattern shape regardless of a physical distance between the two positions P1 and P2. In addition, according to an advantageous example, when the PUF device includes a laminate in which a plurality of metal patterns are stacked, as illustrated in the schematic diagram of FIG. 8, an electrical connection path from one position (input signal) to another position (output signal) of the laminate may be formed from one metal pattern to another metal by contact between metal patterns constituting the laminate, so random and unpredictable ohmic contact exhibits intrinsic electrical resistance.

As described above, the PUF pattern exhibits unpredictable electrical resistance regardless of a physical distance (Euclidean distance) between one position (input signal) and another position (output signal). A private key with a random number may be generated by such a random electrical resistance characteristic.

In order to measure the electrical resistance at various physical distances, the PUF device may include three or more electrodes electrically connected to the PUF pattern and connected at different positions. As the number of electrodes increases, the number of electrode pairs for which the electrical resistance is measured increases. As a practical example, the PUF device may include 3 to 20, 4 to 15, or 5 to 15 electrodes.

FIG. 9 is an optical photograph of a PUF device in which five electrodes are formed at different positions in a laminate in which two layers of metal patterns are stacked, and a region shown in yellow squares is an optical aligner for light irradiation.

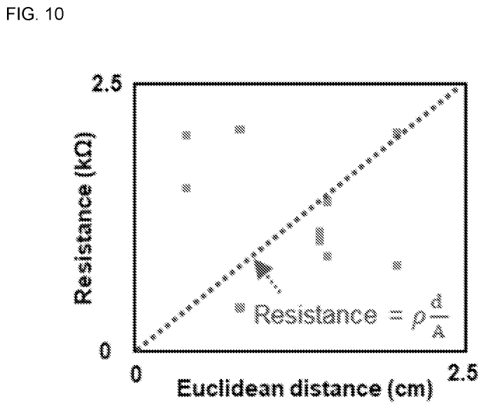

FIG. 10 illustrates a result of measuring electrical resistance for each different electrode pair selected from five electrode groups in the PUF device of FIG. 9. As may be seen from FIG. 10, it may be confirmed that an unpredictable resistance value appears for each electrode pair regardless of the physical distance (Euclidean distance) of the electrode pair.

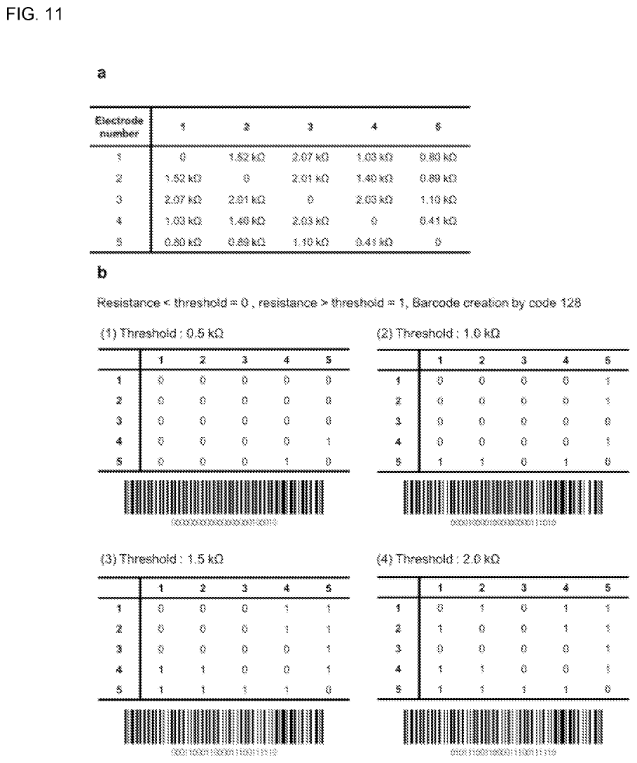

FIG. 11 illustrates an example of generating a private key using the electrical unique characteristic of the electrical resistance values for each electrode pair, FIG. 11A illustrates the measured electrical resistance values for each electrode pair, and FIG. 11B illustrates an example of generating binary keys for each threshold value by converting electrical resistance below a threshold value into 0 and electrical resistance greater than or equal to the threshold value into 1 based on several threshold values of 0.5, 1.0, 1.5, and 2.0.

In addition, a grate-shaped inorganic pattern with a sub-wavelength size, advantageously a metal pattern, generally exhibits very strong wavelength and polarization-dependent optical dichroism, and the PUF pattern also exhibits wavelength and polarization-dependent optical dichroism. Due to this polarization-dependent optical dichroism, the PUF device may have the optical unique characteristic.

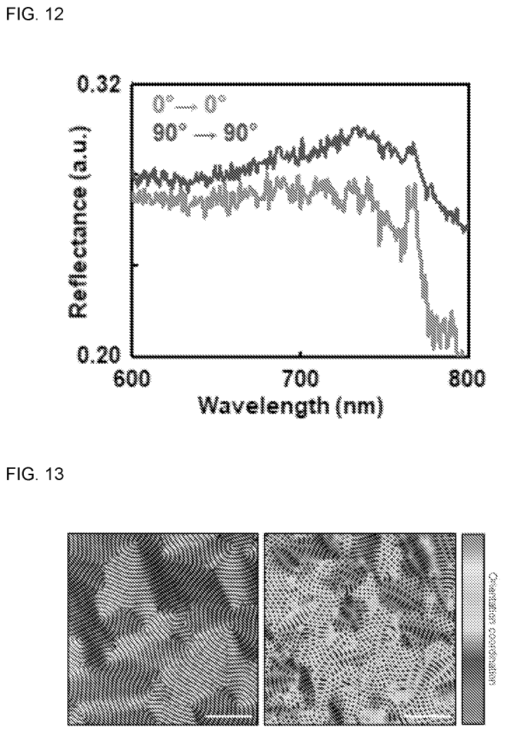

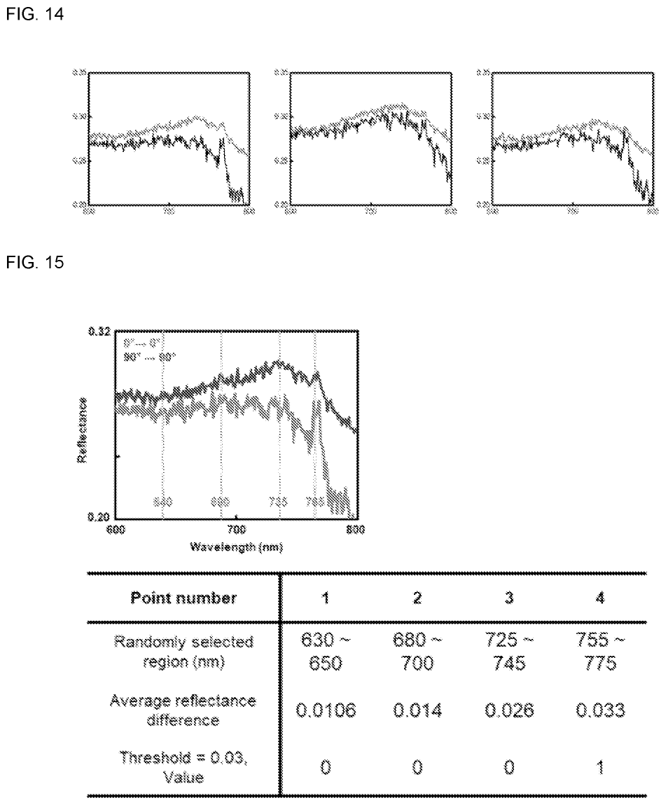

FIG. 12 is a diagram illustrating measurement of reflectance according to a wavelength of light when polarized light (0°, 90°) is irradiated to the PUF device. As may be seen from the results of FIG. 12, it may be seen that the reflectance of the PUF pattern varies according to the polarization of the incident light and the wavelength of the light. This reflectance varies depending on a direction of the grate. Accordingly, when a spot size of light irradiated to the PUF pattern is smaller than or equivalent to a correlation length based on the orientation of the metal layers constituting the metal pattern as illustrated in FIG. 13 (diagram illustrating color mapping of metal layer orientation in a laminate in which a single metal pattern and two metal patterns are stacked), independent and unpredictable reflectance spectra are obtained for each region where light is irradiated. FIG. 14 is a diagram illustrating reflectance spectra according to a polarization direction and wavelength (600 to 800 nm) of light obtained for each region by irradiating light polarized with a spot size (25 μm, the size of the region to which light is irradiated) smaller than the alignment reference correlation length of the metal layers to different regions of the PUF pattern.

FIG. 15 illustrates an example in which in the reflectance spectrum, a size (20 nm) of a band is set, the difference in reflectance in the size of the band set by several random wavelength positions is calculated, and the binary key is generated by being converted into 0 when the reflectance is less than the threshold value based on the threshold value (0.03) and by being converted into 1 when the reflectance is greater than or equal to the threshold value.

As described above, the PUF pattern has the unique characteristics due to the shape, the unique characteristics due to the defect distribution, the unique characteristics due to the electrical characteristic, and the unique characteristics due to the optical characteristic.

The PUF pattern included in the PUF device may have a fine size of several mm×several mm at an ultra-fine size of 1 μm×1 μm that ensures the high encryption capacity, and a height of a single nano-pattern may be 10 to 30 nm.

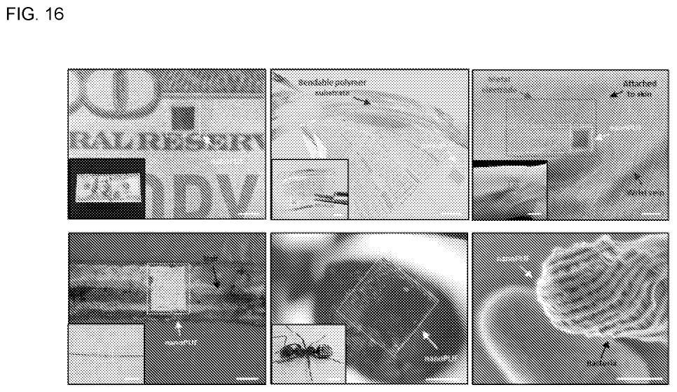

FIG. 16 illustrates an example in which the PUF device has been introduced into various objects, and illustrates an example in which the PUF device introduced into banknotes, flexible polymer substrates, human skin, hair, ants, and bacteria. As in one example illustrated in FIG. 20, the PUF device may be miniaturized and flexible, and thus, may be easily integrated into a non-planar deformable surface with a hidden label.

The present invention includes a secure module including the above-described PUF device.

In one embodiment, the secure module may further include a stimulus unit for obtaining a response by applying an external stimulus to the PUF pattern. For example, when using the shape characteristic or the defect characteristic as the unique characteristics, the stimulus unit may include an image acquisition unit for acquiring image (grayscale image) data of the PUF pattern. For example, when the response characteristic to the electrical stimulus is used as the unique characteristic, the stimulus unit may include a resistance detection unit that measures electrical resistance for each different electrode pair among an electrode set including three or more electrodes electrically connected to the PUF pattern. For example, when the response characteristic to the light stimulus is used as a unique characteristic, the stimulus unit may include an optical unit that includes a light source unit generating polarized light and irradiating the generated light to the PUF pattern and a detector detecting light reflected from the PUF pattern. In this case, the light source unit may include a light source for generating visible light, an optical filter for polarizing light, a lens for concentrating the polarized light, and the like. In this case, the spot size of the concentrated light may be in the range of 5 to 30 μm, but this concentration of light is not necessarily made. For example, light is concentrated to a spot size of an appropriate level, but a mask having a through hole with a diameter of 5 to 30 μm is placed in the PUF pattern region (partial region) to which light is irradiated, so the light may be incident on the PUF pattern through the through hole.

In one embodiment, the secure module may include a key generation unit that receives information generated from the PUF device by the stimulus unit and generates a private key.

When the shape characteristic as the unique characteristics is used, the key generation unit converts a PUF pattern or a gray scale image (having a preset resolution) of a preset sub PUF region(s) into a binary image, and converts the binary image into a one-dimensional vector to generate a private key. In this case, the conversion into the binary image may be performed using a pixel average value of the gray scale image as a reference (threshold value). In addition, the challenge pattern may be applied to the binary image, the response pattern may be obtained through the arithmetic or logical operation, and the private key may be generated by converting the response pattern into a one-dimensional vector.

When the defect characteristic as the unique characteristics is used, the key generation unit may extract defects from the PUF pattern or the gray scale image of the preset sub PUF region(s) to generate the binary image of the defect pattern and convert the binary image of the defect pattern into the one-dimensional vector to generate the private key. In this case, the terminations, bifurcations, and contact points between two adjacent nano-patterns, and extraction may be defined as the type of defects and the extraction may be made for each type of defects. Accordingly, the defect pattern binary image may be generated for each type of defects, and the private key may be generated from a merged image in which different types of defect pattern binary images are merged or one type of defect pattern binary image.

When the electrical response characteristic as the unique characteristics is used, the key generation unit may generate the private key by converting the electrical resistance for each electrode pair into binary data using the electrical resistance result for each electrode pair as a reference, based on the threshold value of electrical resistance.

In the case of using the light response characteristic as the unique characteristics, the key generation unit may set the size of the band, calculate the difference in reflectance within the band set at a plurality of arbitrary wavelengths based on reflectance according to the light wavelength, and generate the private key by converting the difference in reflectance into the binary data using the threshold value of the reflectance as a reference.

The present invention includes the method of manufacturing a PUF device described above.

The method of manufacturing a device for a physical unclonable function according to the present invention includes: a) preparing a thin film of spontaneous phase separated self-assembled structure by forming a thin film of a block copolymer on a substrate and annealing the thin film; and b) removing one of unit blocks of the block copolymer from the thin film of the self-assembled structure. The nano-pattern (organic pattern) of organic matter may be prepared by step b).

On the other hand, the organic pattern or an inorganic pattern may be prepared by using the thin film of the self-assembled structure from which one block is removed obtained in step b) as a mold. That is, after step b), the inorganic pattern or organic pattern may be prepared by c) preparing an organic-inorganic composite thin film by filling the empty space from which the one block is removed with an inorganic matter or preparing a heterogeneous organic composite thin film by filling the empty space with the organic matter; and d) obtaining the nano-pattern by removing the organic matter due to the block copolymer from c) the composite thin film.

The step of preparing a thin film of a self-assembled structure by annealing the block copolymer thin film may be performed by a method generally used to prepare a self-assembled structure such as a lamellar structure, a cylinder structure, and a spherical structure using a random copolymer of a hydrophilic unit block and a hydrophobic unit block. As an example, this may be performed with reference to Korean Patent Laid-Open Publication No. 10-2017-0054672 or Korean Patent Laid-Open Publication No. 10-2013-0138399 provided by the present applicant. According to an advantageous example, the self-assembled structure of step a) may be the random lamellar structure.

Specifically, examples of the block polymer may include two or more different repeating units selected from polyurethane, epoxy polymer, polyarylene, polyamide, polyester, polycarbonate, polyimide, polysulfone, polysiloxane, polysilazane, polyether, polyurea, polyolefin, vinyl-based addition polymers, and acrylic polymers, and more specifically, any one selected from polystyrene-block-polymethylmethacrylate, polybutadiene-polybutylmethacrylate, polybutadiene-block-polydimethylsiloxane, polybutadiene-block-polymethylmethacrylate, polybutadiene-block-polyvinyl pyridine, polybutylacrylate-block-polymethylmethacrylate, polybutylacrylate-block-polyvinylpyridine, polyisoprene-block-polyvinylpyridine, polyisoprene-block-polymethylmethacrylate, polyhexylacrylate-block-polyvinylpyridine, polyisobutylene-block-polybutylmethacrylate, polyisobutylene-block-polymethylmethacrylate, polyisobutylene-block-polybutylmethacrylate, polyisobutylene-block-polydimethylsiloxane, polybutylmethacrylate-block-polybutylacrylate, polyethylethylene-block-polymethylmethacrylate, polystyrene-block-polybutylmethacrylate, polystyrene-block-polybutadiene, polystyrene-block-polyisoprene, polystyrene-block-polydimethylsiloxane, polystyrene-block-polyvinylpyridine, polyethylethylene-block-polyvinylpyridine, polyethylene-block-polyvinylpyridine, polyvinylpyridine-block-polymethylmethacrylate, polyethylene oxide-block-polyisoprene, polyethylene oxide-block-polybutadiene, polyethylene oxide-block-polystyrene, polyethylene oxide-block-polymethyl methacrylate, polyethylene oxide-block-polydimethylsiloxane, polystyrene-block-polyethylene oxide, polystyrene-block-polymethylmethacrylate-block-polystyrene, polybutadiene-block-polybutylmethacrylate-block-polybutadiene, polybutadiene-block-polydimethylsiloxane-block-polybutadiene, polybutadiene-block-polymethylmethacrylate-block-polybutadiene polybutadiene-block-polyvinylpyridine-block-polybutadiene, polybutylacrylate-block-polymethylmethacrylate-block-polybutylacrylate, acrylic polymer ronitrile-block-poly(n-butylacrylate), acrylic polymer as nitrile-block-poly(ε-caprolactone), polydimethylsiloxane-block-polysulfone, polymethylmethacrylate-block-poly(2-hydroxyethyl methacrylate), polybutylacrylate-block-polyvinylpyridine-block-polybutylacrylate, polyisoprene-block-polyvinylpyridine-block-polyisoprene, polyisoprene-block-polymethylmethacrylate-block-polyisoprene, polyhexylacrylate-block-polyvinylpyridine-block-polyhexylacrylate, polyisobutylene-block-polybutylmethacrylate-block-polyisobutylene, polyisobutylene-block-polymethylmethacrylate-block-polyisobutylene, polyisobutylene-block-polybutylene methacrylate-block-polyisobutylene, polyisobutylene-block-polydimethylsiloxane-block-polyisobutylene, polybutylmethacrylate-block-polybutylacrylate-block-polybutylmethacrylate, polyethylethylene-block-polymethylmethacrylate-block-polyethylethylene, polystyrene-block-polybutylmethacrylate-block-polystyrene, polystyrene-block-polybutadiene-block-polystyrene, polystyrene-block-polyisoprene-block-polystyrene, polystyrene-block-polydimethylsiloxane-block-polystyrene, polystyrene-block-polyvinylpyridine-block-polystyrene, polyethylethylene-block-polyvinylpyridine-block-polyethylethylene, polyethylene-block-polyvinyl pyridine-block-polyethylene, polyvinylpyridine-block-polymethylmethacrylate-block-polyvinylpyridine, polyethyleneoxide-block-polyisoprene-block-polyethyleneoxide, polyethyleneoxide-block-polybutadiene-block-polyethylene oxide, polyethylene oxide-block-polystyrene-block-polyethylene oxide, polyethylene oxide-block-polymethyl methacrylate-block-polyethylene oxide, polyethylene oxide-block-polydimethylsiloxane-block-polyethylene oxide, and polystyrene-block-polyethylene oxide-block-polystyrene, and the number average molecular weight may be 30,000 to 300,000 g/mol, but is not limited thereto. The block copolymer may be derived from 30 to 70 wt % of a hydrophilic monomer and 70 to 30 wt % of a hydrophobic monomer, but is not limited thereto.

The solvent is sufficient as long as it dissolves the block copolymer and may be easily removed by volatilization. For example, examples of the solvent may include an ether solvent such as ethylene glycol monobutyl ether acetate, a lactone solvent such as gammabutyrolactone, an aromatic solvent such as cyclohexylbenzene, or a sulfone solvent such as dimethyl sulfoxide. In addition, examples of the solvent may include solvents such as dimethyl formamide, N-methyl-2-pyrrolidone, N-ethyl-2-pyrrolidone, diisononyl-1,2-cyclohexane-dicarboxylate, 1,3-dimethylpropyleneurea tri-n-octylphosphine oxide, hexamethylphosphoramide, 3-methyl-2-oxazolidone, 2-oxazolidone, catechol, N,N-dibutylurea, toluene, propylene glycol monomethyl ether acetate, and anisole, but is not limited thereto.

The block copolymer film may be prepared by applying a solution in which the block copolymer is dissolved in a solvent to a substrate. The concentration of the block copolymer in the solution may be 0.5 to 3 wt %, but is not limited thereto. As is known, when the lamellar structure is to be manufactured, the surface of the substrate to which the solution is applied may be a neutral surface. As is known, the neutral surface is a surface neutral to the block copolymer, and the neutral surface may be formed by surface-treating the substrate by any one method selected from a self-assembled monolayer (SAM), a polymer brush, and a cross-linked random copolymer mat (MAT). The typically used brush treatment balances an interfacial tension between the hydrophobic unit block and the hydrophilic unit block, so the lamellar structure is easily formed.

The annealing that results in the spontaneous phase separation may include thermal annealing, solvent annealing, and combinations thereof. It is sufficient if the annealing is performed under previously established conditions in consideration of the spherical block copolymer material. Specifically, the thermal annealing is a method of aligning the block copolymer by applying heat higher than or equal to the glass transition temperature of the block copolymer, and for example, the annealing may be performed at a temperature of 150 to 300° C. for 1 minute to 10 hours. The solvent annealing is a method of imparting fluidity to a polymer chain by exposing a block copolymer applied on a substrate under a solvent vapor. As the solvent, for example, at least one selected from toluene, acetone, benzene, ethanol, n-butanol, n-heptanol isopropane, hexane, cyclohexane, and the like may be used, but the present invention is not necessarily limited thereto. The solvent annealing may be performed at room temperature, or may be performed together with thermal annealing. For example, the solvent annealing may be performed at a temperature of room temperature to 300° C. for 1 to 60 hours.

As described above, it is possible to prepare the inorganic pattern or organic pattern by forming the self-assembled structure of the block copolymer through a known method, selectively removing any one unit block of the block copolymer to obtain an organic pattern, or using the lamellar structure in which one unit block is selectively removed as a mold flask to depositing the inorganic matter or organic matter, and then removing the mold flask.

The selective removal of one of the unit blocks of the block copolymer forming the self-assembled structure may be performed using any one or more methods of dry etching or wet etching. The wet etching may be performed using an etchant that selectively dissolves only one unit block, and the dry etching may perform using reactive ion etch (RIE). However, in the case of the lamellar structure, there is a risk of damage to the structure during the etching process due to capillary force, so it is better to use the RIE. Since there is a difference in the removal rate depending on the presence or absence of carbon or oxygen in the polymer during the etching through the RIE, it goes without saying that the RIE etching time and intensity may be adjusted so that one unit block is selectively etched in consideration of this.

After the one-unit block is removed from the self-assembled structure by the etching, the film of the self-assembled structure from which the one-unit block is removed may be used as the organic pattern.

In contrast, by using the film of the self-assembled structure from which one unit block has been removed as the mold flask, it is possible to prepare organic patterns with other heterogeneous materials (materials different from block copolymer materials) that have intrinsic properties such as elasticity or chemical resistance more suitable for the environment of use, or patterns of inorganic matter rather than organic matter.

In detail, the deposition of the inorganic matter or organic matter may be performed so that a space is filled with the film of the self-assembled structure from which one unit block is removed as a mold. The inorganic matter may be an insulator (ceramic), a metal, or a semiconductor, but it is preferable that the inorganic matter be a metal so that the PUF device may have more diverse unique characteristics. The deposition may be applied to both physical vapor deposition (PVD) and chemical vapor deposition (CVD), and for example, vacuum deposition such as resistance heating deposition, electron beam heating deposition, high-frequency heating deposition, and laser beam heating deposition; sputtering, such as direct current (DC) sputtering, radio frequency (RF) sputtering, bias sputtering; any one or two or more methods selected from ion plating, epitaxial, atmospheric CVD, reduced pressure CVD, plasma CVD, optical CVD, atomic layer deposition (ALD), and the like may be used.

After the deposition of the material (organic matter or inorganic matter) is performed, a step of removing one unit block (residual organic matter) remaining in the block copolymer to obtain a nano-pattern may be performed. The removal of the residual organic matter may be performed using the etching such as the dry etching or the wet etching, or through a lift-off method.

Thereafter, in consideration of the specific purpose of other PUF devices from the substrate used for preparing the block copolymer, when transferring the nano-pattern prepared with a substrate suitable for the purpose or laminating the nano-pattern, the step of removing the substrate used in preparing the block copolymer may be further performed. The removal of the substrate may be performed using the wet etchant that selectively dissolves the substrate, but the present invention is not limited thereto. The transfer of the nano-pattern or the movement for lamination is sufficient as long as it is performed by a method commonly used to transfer or move a two-dimensional nanostructure. The transfer/movement or the like may be made using, for example, the well-known polydimethylsiloxane stamp, but the present invention is not limited thereto.

After the PUF pattern is prepared by the preparation of the nano-pattern or the lamination of the nano-pattern, the step of forming three or more electrodes electrically connected to the PUF pattern and connected to the PUF pattern at different positions may be further performed. In this case, it goes without saying that the positions where the electrodes are connected to the PUF pattern may be random. Specifically, 3 to 20 electrodes, 4 to 15 electrodes, or 5 to 15 electrodes may be formed. The formation of the electrode may be performed by depositing a metal using a mask having a designed electrode pattern (through hole pattern) as a deposition mask, and then removing the mask, but the present invention is not limited thereto.

Hereinabove, although the present invention has been described by specific matters, exemplary embodiments, and the accompanying drawings, they have been provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to these exemplary embodiments, but the claims and all of modifications equal or equivalent to the claims are intended to fall within the scope and spirit of the present invention.

1. A device for a physical unclonable function including a nano-pattern corresponding to a self-assembled structure.

2. The device of claim 1, wherein the nano-pattern is a pattern corresponding to a pattern of one of the two materials forming the self-assembly structure.

3. The device of claim 1, wherein the self-assembled structure is a self-assembled structure by spontaneous phase separation of a polymer.

4. The device of claim 1, wherein the self-assembled structure is a random lamellar structure.

5. The device of claim 1, wherein the nano-pattern is an organic pattern or an inorganic pattern.

6. The device of claim 1, further comprising:
a laminate in which two or more nano-patterns having different patterns are stacked.

7. The device of claim 1, wherein the self-assembled structure has 5 to 20 defects per 1 μm² area.

8. The device of claim 1, further comprising:
an electrode set electrically connected to the nano-pattern and including three or more electrodes spaced apart from each other.

9. The device of claim 1, wherein a private key of the device is based on one or more of unique characteristics I) and II) below.
I) Shape characteristic
II) Defect characteristic

10. The device of claim 5, wherein the inorganic pattern is a metal pattern, a semiconductor pattern, or an insulator pattern.

11. The device of claim 5, wherein a private key of the device is based on one or more of unique characteristics of I) to IV) below.
I) Shape characteristic
II) Defect characteristic
III) Response characteristic to electrical stimulus
IV) Response characteristic to light stimulus

12. The device of claim 9, wherein the defect characteristic includes binary image information of a defect.

13. The device of claim 9, wherein the defect includes terminations or bifurcations or the terminations and bifurcations.

14. The device of claim 9, wherein when the device includes the laminate in which two or more nano-patterns having different patterns are stacked, the defect includes crossing points of the two nano-patterns.

15. The device of claim 9, wherein the shape characteristic includes binary image information of the nano-pattern.

16. The device of claim 11, wherein the response characteristic to the electrical stimulus includes electrical resistance measured for each different electrode pair from an electrode set including three or more electrodes electrically connected to the nano-pattern.

17. The device of claim 11, wherein the response characteristic to the light stimulus includes reflectance for each wavelength of polarized light.

18. A secure module including the device for a physical unclonable function of claim 1.

19. A method of manufacturing a device for a physical unclonable function, comprising:
a) preparing a thin film of spontaneous phase separated self-assembled structure by forming a thin film of a block copolymer on a substrate and annealing the thin film; and
b) removing one of unit blocks of the block copolymer from the thin film of the self-assembled structure.

20. The method of claim 19, further comprising:
after step b),
c) preparing an organic-inorganic composite thin film by filling the empty space from which the one block is removed with an inorganic matter; and
d) removing an organic matter from the block copolymer from the organic-inorganic composite thin film.

21. (canceled)

22. (canceled)

23. (canceled)
